(19) United States
(12) Patent Application Publication
(10) Pub. No.: US 2025/0312850 A1
(43) Pub. Date: Oct. 9, 2025

(54) CALIBRATION METHOD AND PRINTING SYSTEM CONFIGURED TO PRODUCE A THREE-DIMENSIONAL WORKPIECE

(71) Applicant: NIKON SLM SOLUTIONS AG, Lübeck (DE)

(72) Inventor: Jan Lukas Matyssek, Lübeck (DE)

(21) Appl. No.: 18/867,855

(22) PCT Filed: May 22, 2023
(86) PCT No.: PCT/EP2023/063578

§ 371 Date: Nov. 21, 2024

(30) Foreign Application Priority Data
Jun. 7, 2022 (DE) 10 2022 114 290.6
Jun. 8, 2022 (DE) 10 2022 114 445.3

(51) Int. Cl. B22F 10/31; B22F 10/36; B22F 10/85; B22F 12/45; B33Y 10/00; B33Y 30/00; B33Y 50/02

(52) U.S. Cl. CPC B22F 10/31; B22F 10/36; B22F 10/85; B22F 12/45; B33Y 10/00; B33Y 30/00; B33Y 50/02

(57) ABSTRACT

A calibration method for a printing system configured to produce a three-dimensional workpiece is provided. A first image of a first portion of a calibration plate is obtained, a position of at least a part of a calibration mark of the calibration plate is detected in the first image, an irradiation system of the printing system irradiates, with a laser beam, a point on the first portion of the calibration plate, a second image of the first portion is obtained, a position of a spot of light formed by the laser beam is detected in the second image, and the printing system is calibrated based on the detected position of the at least one part in the first image and the detected position of the spot of light in the second image. A corresponding printing system is also provided.

The invention is directed to a calibration method for a printing system, the printing system configured to produce a three-dimensional workpiece. Further, the invention is directed to a printing system of this kind.

Powder bed fusion is an additive layering process by which pulverulent, in particular metallic and/or ceramic raw materials can be processed to three-dimensional work pieces of complex shapes. To that end, a raw material powder layer is applied onto a carrier and subjected to laser radiation in a site selective manner in dependence on the desired geometry of the work piece that is to be produced. The laser radiation penetrating into the powder layer causes heating and consequently melting or sintering of the raw material powder particles. Further raw material powder layers are then applied successively to the layer on the carrier that has already been subjected to laser treatment, until the work piece has the desired shape and size. Powder bed fusion may be employed for the production or repairing of prototypes, tools, replacement parts, high value components or medical prostheses, such as, for example, dental or orthopaedic prostheses, on the basis of CAD data.

An printing system for producing three-dimensional work pieces by powder bed fusion as described, e.g., in WO 2019/141381 A1, comprises a carrier, also referred to as build platform, configured to receive multiple layers of raw material and an irradiation unit, also referred to irradiation system, configured to selectively irradiate laser radiation onto the raw material on the carrier in order to produce a work piece. The irradiation unit may be provided with a spatial light modulator configured to split a laser beam into at least two sub-beams. Thus, a plurality of sub-beams, generally referred to as laser beams, can be used to selectively irradiate the raw material on the build platform.

Planned positions on the raw material that are to be irradiated by the laser beam(s) may be defined by or derived from (e.g., computer assisted design, CAD) workpiece data describing the workpiece to be manufactured. Due to manufacturing tolerances, temperature changes and other causes, the irradiation system might guide a laser beam to a position on the raw material that deviates from a planned position. In other words, there may be a misalignment between an irradiated position on the raw material and a corresponding planned position. Such a misalignment may lead to a lower rigidity of printed workpieces, workpiece dimensions exceeding acceptable predefined manufacturing tolerances and other disadvantages. To reduce or eliminate the misalignment between irradiated positions on the raw material and planned positions, the printing system may be calibrated.

It is an object of the present invention to provide a calibration method for a printing system configured to produce a three-dimensional work piece and a printing system of this kind, which allow an efficient and exact calibration of the printing system.

The raw material powder layer may be applied onto a surface of the build platform by means of a powder application device which is moved across the build platform so as to distribute the raw material powder. The build platform may be a rigidly fixed carrier. Preferably, however, the build platform is designed to be displaceable in vertical direction (e.g., changed in height), so that, with increasing construction height of the work piece, as it is built up in layers from the raw material powder, the build platform can be moved downwards in the vertical direction. One may say that different heights of the build platform correspond to different vertical positions thereof. Further, the build platform may be provided with a cooling device and/or a heating device which are configured to cool and/or heat the build platform.

The build platform and the powder application device may be accommodated within a process chamber which is sealable against the ambient atmosphere. An inert gas atmosphere may be established within the process chamber by introducing a gas stream into the process chamber via a gas inlet. After being directed through the process chamber and across the raw material powder layer applied onto the carrier, the gas stream may be discharged from the process chamber via a gas outlet. The raw material powder applied onto the build platform within the process chamber is preferably a metallic powder, in particular a metal alloy powder, but may also be a ceramic powder or a powder containing different materials. The powder may have any suitable particle size or particle size distribution. It is, however, preferable to process powders of particle sizes<100 μm.

The irradiation system may comprise a laser beam source, which is configured to emit at least one beam of laser light. In particular, the laser beam source of the irradiation system may emit (e.g., linearly polarized) laser light at a wavelength of 450 nm, i.e. “blue” laser light, or laser light at a wavelength of 532 nm, i.e. “green” laser light, or laser light at a wavelength in the rage of 1000 nm to 1090 nm or in the range of 1530 nm to 1610 nm, i.e. “infrared” laser light. If one or more beam splitter cubes are used to split the laser light beam into two or more partial beams, only one partial beam may be used as irradiation beam while obstructing the other partial beams. Alternatively, one or more partial beams may be guided to different irradiation systems in one or more printing systems.

The irradiation system may irradiate a build area with a single laser beam. It is, however, also conceivable that the irradiation system irradiates two or more laser beams onto the build area. The plural laser light beams irradiated onto the build area by the irradiation system may be emitted by suitable sub-units of the laser beam source. The build area may correspond to an area of the printing system where the workpiece is to be produced, in particular an area on and above the build platform in the vertical direction. The irradiation system may be controlled by a processor, in particular to irradiate a (e.g., planned) position and/or point (e.g., on the raw material powder layer) in the build area.

The irradiation system may also comprise at least one optical scanning system for splitting, guiding and/or processing the at least one laser beam emitted by the laser beam source. The optical scanning system may comprise one or more optical elements such as an object lens and a scanner unit, the scanner unit preferably comprising a diffractive optical element and/or a deflection mirror. The at least one optical scanning system may be configured to guide a laser beam to the build area. The irradiation system may comprise a plurality of optical scanning systems, each configured to guide a different one of the laser beams to the build area. In one example, the build area is divided into a plurality of (e.g., non-overlapping) sections, wherein each of the optical scanning systems is configured to guide the different one of the laser beams to a different set of the sections. The different sets of sections may differ from one another in shape, size and/or position, and may overlap one another.

The printing system may comprise an adjustment system having a plurality of configurations, each configuration yielding a different size and/or shape of a point irradiated with the laser beam(s). The adjustment system may be configured to change a laser beam diameter, a shape of a cross section of a laser beam and/or a focus of a laser beam. The adjustment system may comprise one or more optical elements such as a lens, an aperture and/or a mirror. The adjustment system may be part of the irradiation system, in particular part of the optical scanning system. Alternatively, the adjustment system may be separate from the optical scanning system. Different adjustment systems may be provided for different laser beams.

A calibration plate may be provided which is configured to be arranged in the build area. The calibration plate may for example be arranged on the build platform, on the process chamber floor, on top of a powder application device, or may be realized movable into a space within the process chamber in or above the build area. The calibration plate may carry at least one calibration mark (e.g., on a surface of the calibration plate). The calibration plate may carry a plurality of calibration marks, for example arranged in a symmetric pattern. One or more calibration marks may have a circular outline. Each calibration mark may have a higher reflectivity of light compared with a portion of the calibration plate bordering or surrounding the respective calibration mark. The calibration plate may be an anodized aluminium plate. Each calibration mark may be formed by a part of the aluminium plate where the surface layer formed by the anodization has been removed (e.g., by milling, scratching or laser evaporation).

The printing system may comprise an imaging system. The imaging system may be arranged and configured to capture images of at least a part of the build area, in particular a segment of the build area in which segment the calibration plate is or can be arranged. The imaging system may comprise an image sensor such as a camera. The imaging system may be configured to capture an image using a predefined electromagnetic spectrum. Phrased differently, the imaging system may be sensitive only for light having a wavelength that falls within the predefined electromagnetic spectrum. For example, the imaging system may comprise one or more wavelength filter(s) arranged such that all light originating at the build area (e.g., at a surface of the calibration plate arranged in the build area) and falling onto the image sensor falls within the predefined electromagnetic spectrum. The predefined electromagnetic spectrum may differ from a wavelength of the laser beam(s). That is, the imaging system may be configured to be insensitive to light having the wavelength(s) of the laser beam(s). The wavelength(s) of the laser beam(s) may lie outside the predefined electromagnetic spectrum. The imaging system may include one or more optic components such as mirrors, lenses and apertures, the one or more optic components arranged and configured to guide light from the build area toward the image sensor. The imaging system may share at least one of the optic components with the irradiation system. For example, the image sensor may be arranged and configured to capture an image via an optical scanning system of the irradiation system.

The printing system may comprise an illumination unit. The illumination unit may comprise one or more light emitting elements, for example one or more light emitting diodes. The illumination unit may be arranged and configured to illuminate at least a portion of the calibration plate when the calibration plate is arranged in the build area. The illumination unit may be configured to illuminate at least the build area. The illumination unit may be configured to emit light having a predefined wavelength spectrum (e.g., for illuminating at least a portion of the calibration plate). The predefined wavelength spectrum may correspond to, fall into or overlap with the predefined electromagnetic spectrum. In other words, the imaging system may be sensitive to light emitted from the illumination unit (e.g., and reflected by a calibration mark of the calibration plate). The calibration mark may exhibit a higher reflection of light of the predefined wavelength spectrum than the portion of the calibration plate bordering or surrounding the respective calibration mark.

In accordance with the present disclosure, a calibration method for a (e.g., the) printing system is provided, the printing system configured to produce a three-dimensional workpiece. The method is performed by a (e.g., the) processor and comprises a step (a) of obtaining a first image, captured by an (e.g., the) imaging system of the printing system, of a first portion of a (e.g., the) calibration plate arranged in a (e.g., the) build area of the printing system, the first portion comprising at least one part of at least one calibration mark carried by the calibration plate. The method may comprise a step of triggering the imaging system to capture the first image. Alternatively, the first image may be captured beforehand and then retrieved from a database.

The method further comprises a step (b) of detecting (e.g., only) a position of the at least one part in the first image. The positon may be detected in a frame coordinate system, FCS, of the imaging system. The FCS may be associated with the first image. The position may be detected based on the first image, using one or more of feature extraction, feature recognition, template matching and machine vision, for example based on one or more predefined (e.g., geometrical and/or optical) properties of the at least one calibration mark. The (e.g., at least one part of the) at least one calibration mark may have an outline or shape such that an orientation thereof cannot be (e.g., unambiguously) detected and/or determined based on the first image. As only the position of the at least one part needs to be detected in the first image, the method may still yield a reliable calibration in case of circular calibration marks.

The method further comprises a step (c) of controlling an (e.g., the) irradiation system of the printing system to irradiate, with a laser beam, a point on the first portion of the calibration plate arranged in the build area, a step (d) of obtaining a second image, captured by the imaging system, of the first portion of the calibration plate arranged in the build area, the second image comprising a spot of light formed by the laser beam irradiating the point on the first portion of the calibration plate arranged in the build area, and a step (e) of detecting (e.g., only) a position of the spot of light in the second image. The method may comprise a step of triggering the imaging system to capture the second image. The positon of the spot of light may be detected in the FCS, which may be associated with the second image. The position of the spot of light may be detected based on the second image, using one or more of feature extraction, feature recognition, template matching and machine vision, for example based on one or more predefined (e.g., geometrical and/or optical) properties of the at least one spot of light. The spot of light may have an outline or shape such that an orientation thereof cannot be (e.g., unambiguously) detected and/or determined based on the second image. As only the position of the spot of light needs to be detected in the second image, the method may still yield a reliable calibration in case of circular light spots.

The method comprises a step (f) of calibrating the printing system based on the detected position of the at least one part in the first image and the detected position of the spot of light in the second image. The printing system may be calibrated based on a comparison of the detected position of the at least one part in the first image and the detected position of the spot of light in the second image. The first image and the second image may cover the same field of view and/or identical regions. Alternatively, or in addition, an alignment of the first portion in the first image may be identical to an alignment of the first portion in the second image. The calibration plate may have the same orientation in the build area during the capture of the first image and the capture of the second image. The printing system may be calibrated based on a comparison of the detected position of the at least one part in the FCS and the detected position of the spot of light in the FCS. For example, the irradiation system or an (e.g., the) optical scanning system comprised in the irradiation system (e.g., and used to guide the laser beam to the point on the calibration plate) may be calibrated to calibrate the printing system. For calibrating the printing system, coordinate systems of the optical scanning system, the imaging system and/or other components of the printing system may be adjusted (e.g., relative to one another). Calibrating the printing system may comprise determining one or more transformations between these coordinate systems.

The calibration method thus uses two distinct images, wherein the first image is used for detecting a position of at least a part of a calibration mark carried by the calibration plate and the second image is used for detecting a position of a spot of light formed by a laser beam irradiating a point on the calibration plate. The images may be captured using imaging parameters (e.g., an illumination setting, a focus setting, an exposure time setting and/or a contrast setting) adapted to optimize the respective detection, and are preferably captured at different times. For example, an (e.g., the) illumination unit may be configured to illuminate at least the first portion of the calibration plate when the calibration plate is arranged in the build area. The first image may be captured during illumination of the first portion, whereas the second image may be captured while the illumination unit is turned off. The (e.g., at least one part of the) at least one calibration pattern may not be visible and/or detectable in the second image.

The method may comprise obtaining an alignment image set comprising one or more images, captured by the imaging system, of at least one portion of the calibration plate arranged in the build area. An orientation of the calibration plate may be determined (e.g., relative to the FCS) based on the alignment image set. The printing system may be calibrated (e.g., further) based on the determined orientation of the calibration plate.

The method may comprise detecting, in at least one of the images of the alignment image set, a geometrical element on the calibration plate and determining an orientation of the detected geometrical element in the at least one image. The orientation of the calibration plate may then be determined based on the determined orientation of the detected geometrical element. The orientation of a single geometrical element detected in a single image may be sufficient to determine the orientation of the calibration plate.

The geometrical element may be a non-rotationally-symmetric element. The geometrical element may have a non-circular outline or shape. The geometrical element may have a finite number of symmetry axes. The geometrical element may comprise or consist of at least two lines. Two or more of the lines may be non-parallel and/or intersect one another. Examples of such geometrical elements include a pair of lines in an L-shape, a pair of lines in a cross-shape or a plus-shape, four lines forming a rectangle or a square and arrangements of circles in an L-or square-shape. Alternatively, the geometrical element may comprise or consist of a non-symmetrical two-dimensional pattern such as a (e.g., computer-readable) two-dimensional code, for example a Quick Response, QR, code. The geometrical element may be arranged on the calibration plate adjacent to a calibration mark or such that it surrounds a calibration mark. The geometrical element in one example is joined to (e.g., transitions into) a calibration mark. The geometrical element may exhibit a higher reflection of light of the predefined wavelength spectrum than the portion of the calibration plate bordering or surrounding the respective calibration mark.

The method may comprise detecting, based on the alignment image set, a plurality of reference elements of the calibration plate. The plurality of reference elements may be detected in one image of the alignment image set, or different reference elements of the plurality of reference elements may be detected in different images of the alignment image set. Based on the alignment image set, a position of each detected reference element may be determined. For example, the positions of all reference elements in the one image of the alignment image set may be determined, or the position of the respective different reference elements in the different images may be detected. The method may comprise determining the orientation of the calibration plate based on the determined positions of the detected reference elements. That is, the positions of the plurality of reference elements, detected in a single image or in multiple images of the alignment image set, may be used to determine the orientation of the calibration plate. No orientations of the individual reference elements may need to be detected. This allows for using reference elements which individual orientation cannot be (e.g., unambiguously) be detected in the image(s) of the alignment image set. It follows that a reference element in accordance with the present disclosure may have a circular shape or outline. One example of a reference element is the calibration mark. That is, the reference elements may correspond to the calibration marks carried by the calibration plate. In one example, the reference element and the calibration mark may have different diameters. The reference element may exhibit a higher reflection of light of the predefined wavelength spectrum than the portion of the calibration plate bordering or surrounding the respective calibration mark.

The alignment image set may comprise or consist of one of more of the following images: (i) the first image, (ii) a third image of a second portion of the calibration plate arranged in the build area, the second portion being different from the first portion, (iii) a plurality of images of different portions of the calibration plate arranged in the build area.

The calibration may be performed and/or repeated (i) for different laser beams of the irradiation system, (ii) for different optical scanning systems of the irradiation system, each configured to guide a different laser beam to the build area, (iii) for different sizes of the point on the calibration plate irradiated with the laser beam, (iv) for different shapes of the point on the calibration plate irradiated with the laser beam, (v) for different configurations of an (e.g., the) adjustment system of the irradiation system, each configuration yielding a different size and/or shape of the point irradiated with the laser beam, (vi) for different first portions, and/or (vii) for different heights of the build platform arranged in the build area and carrying the calibration plate.

In case the irradiation system comprises a plurality of optical scanning systems, each configured to guide a different laser beam to the build area, at least one of (e.g., all of) the plurality of optical scanning systems may be calibrated when calibrating the printing system. Two variants for this procedure will now be described. It is noted that the following variants are not limited to a calibration of the at least one of the optical scanning systems and equally apply to a calibration of the overall printing system or other components thereof.

As a first variant, steps (c) to (e) may be performed for at least one further laser beam, and the printing system may be calibrated based on the detected position of the at least one part in the first image and the detected positions of the respective spots of light in the second images. In other words, a single first image may be used for detecting the position of the at least one part, whereas multiple second images may be used for detecting a respective spot of light of a different laser beam.

As a second variant, the method may comprise a step (c′) of controlling the irradiation system to irradiate, with at least one further laser beam, a different point on the first portion of the calibration plate arranged in the build area. In step (d), the second image captured by the imaging system, of the first portion of the calibration plate arranged in the build area, is obtained. The second image in this variant comprises the spot of light formed by the laser beam irradiating the point on the first portion of the calibration plate arranged in the build area, and further comprises at least one further spot of light formed by the at least one further laser beam irradiating the different point on the first portion of the calibration plate arranged in the build area. The method may further comprise a step (e′) of detecting a position of the at least one further spot of light in the second image. The printing system may then be calibrated based on the detected position of the at least one part in the first image and the detected positions of the spots of light in the second image. In other words, a single first image may be used for detecting the position of the at least one part, and a single second image may be used for detecting a plurality of spots of light of different laser beams. The spots of light may be distinguished based on their (e.g., geometrical and/or optical) properties. These properties may include one or more of the following: a light intensity, a light color, alight spectrum, a light wavelength, a shape, an outline, a beam profile (e.g., Gauss, Top Hat or Donut). The properties of the spots of light may be associated with the respective laser beams, for example using a known relationship between the properties and the laser beams. This may allow calibrating optical scanning systems of different laser beams individually using a single second image comprising a plurality of spots of light generated by the different laser beams irradiating different points on the calibration plate.

In case the irradiation system comprises the adjustment system having a plurality of configurations, each configuration yielding a different size and/or shape of the point irradiated with the laser beam on the calibration element arranged in the build area, the method may comprise performing steps (c) to (e) for each of the plurality of configurations of the adjustment system. The printing system may then be calibrated based on the detected position of the at least one part in the first image and the detected positions of the respective spots of light in the second images.

The method may comprise performing steps (a) to (e) for each of a plurality of different first portions, wherein the printing system is calibrated based on the detected positions of the respective at least one part in the first images and the detected position of the respective spots of light in the second images.

As mentioned above, the printing system may comprise a build platform arranged in the build area and configured to carry the calibration plate. The method may comprise performing steps (a) to (e) for each of a plurality of heights of the build platform when carrying the calibration plate, wherein the printing system is calibrated based on the detected positions of the respective at least one part in the first images and the detected position of the respective spots of light in the second images.

The method may comprise obtaining correction data indicative of geometrical parameters of the calibration plate measured with an external measurement system, wherein the printing system is calibrated based on the correction data.

The method may comprise determining a transformation between (i) a coordinate system of an (e.g., the) optical scanning system of the irradiation system, the optical scanning system configured to guide the laser beam to the build area, and (ii) a coordinate system of the imaging system (e.g., the coordinate system FCS), wherein the printing system is calibrated based on the determined transformation. The coordinate system of the optical scanning system may be referred to as scanning coordinate system, SCS.

The method may comprise controlling the imaging system to capture the first image while at least the first portion of the calibration plate arranged in the build area is illuminated by the illumination unit. Alternatively, or in addition, the imaging system may be controlled to capture the second image(s) while at least the first portion of the calibration plate arranged in the build area is not illuminated by the illumination unit. The imaging system may be controlled to capture all images except for the second image(s) while at least the first portion of the calibration plate arranged in the build area is illuminated by the illumination unit.

The illumination unit may be controlled (e.g., by the processor or by a user) to activate the illumination when the first image is captured. The illumination unit may be controlled (e.g., by the processor or by a user) to activate the illumination when the other image(s) except for the second image are captured. The illumination unit may be controlled (e.g., by the processor or by a user) to deactivate the illumination when the second image(s) are captured.

The imaging unit may be configured to acquire the first image only if the illumination unit is illuminating at least the first portion of the calibration plate arranged in the build area. The imaging unit may be configured to acquire all images except for the second image(s) only if the illumination unit is illuminating at least the first portion of the calibration plate arranged in the build area. The imaging unit may be configured to acquire the second image(s) only if the illumination unit is not illuminating the calibration plate arranged in the build area. To this end, the imaging unit may be coupled to the illumination unit or may comprise a light sensor configured to detect light emitted by the illumination unit.

The imaging system may be arranged such that it captures at least the first image and the second image via an (e.g., the) optical scanning system comprised in the irradiation system, the optical scanning system configured to guide the laser beam to the build area. In this case, the imaging system may comprise an on-axis camera.

One or more position markers may be provided adjacent to the calibration plate arranged in the build area. The one or more position markers may be provided in an area that is not covered with powder material during the formation of a new powder layer by the powder application device. One or more additional position markers may be carried by the calibration plate. The method may comprise a step of capturing a fourth image, by the imaging system, of at least one of the position markers provided adjacent to the calibration plate and at least one of the position markers carried by the calibration plate. Based on the captured fourth image a position and/or orientation of each position marker may be determined. The position(s) and/or orientation(s) may be compared to determine an offset of the calibration plate from a predefined calibration pose of the calibration plate relative to the build area. The position and/or orientation of the calibration plate may then be adjusted (e.g., mechanically and/or manually) to minimize or compensate the offset. The method may then proceed with steps (a) to (f).

After having performed the calibration, the method may be repeated for validation and/or a three-dimensional workpiece may be produced by the printing system.

In accordance with the present disclosure, a printing system for producing a three-dimensional workpiece is provided, comprising an irradiation system configured to selectively irradiate a build area with one or more laser beams, an imaging system configured to capture an image of at least a portion of a calibration plate when the calibration plate is arranged in the build area, and a processor. The processor of the printing system is configured to (a) obtain a first image, captured by the imaging system, of a first portion of the calibration plate arranged in the build area, the first portion comprising at least one part of at least one calibration mark carried by the calibration plate, (b) detect a position of the at least one part in the first image, (c) control the irradiation system to irradiate, with one of the one or more laser beams, a point on the first portion of the calibration plate arranged in the build area, (d) obtain a second image, captured by the imaging system, of the first portion of the calibration plate arranged in the build area, the second image comprising a spot of light formed by the one of the one or more laser beams irradiating the point on the first portion of the calibration plate arranged in the build area, (e) detect a position of the spot of light in the second image, and (f) calibrate the printing system based on the detected position of the at least one part in the first image and the detected position of the spot of light in the second image.

The printing system, in particular the processor, may be configured to perform or carry out the method as described herein above. The printing system may comprise one or more of the following: (i) (e.g., the) one or more optical scanning systems, each configured to guide a different one of the laser beams to the build area, (ii) an (e.g., the) adjustment system having a plurality of configurations, each configuration yielding a different size and/or shape of the point irradiated with the laser beam, (iii) a (e.g., the) build platform arranged in the build area and configured to carry the calibration plate, (iv) an (e.g., the) illumination unit configured to illuminate at least the first portion of the calibration plate when the calibration plate is arranged in the build area, (v) an (e.g., the) on-axis camera, (vi) the calibration plate.

The processor may be configured to calibrate the printing system based on a (e.g., the) comparison of the detected position of the at least one part in the first image and the detected position of the spot of light in the second image.

The processor may be configured to control the imaging system to capture the first image and the second image such that the first image and the second image cover the same field of view and/or such that an alignment of the first portion in the first image is identical to an alignment of the first portion in the second image.

The processor may be configured to calibrate the irradiation system to calibrate the printing system.

The processor may be configured to obtain an (e.g., the) alignment image set comprising one or more images, captured by the imaging system, of at least one portion of the calibration plate arranged in the build area. The processor may be configured to determine an orientation of the calibration plate based on the alignment image set and calibrate the printing system based on the determined orientation of the calibration plate.

The processor may be configured to detect, in at least one of the images of the alignment image set, a (e.g., the) geometrical element on the calibration plate, determine an orientation of the detected geometrical element in the at least one image, and determine the orientation of the calibration plate based on the determined orientation of the detected geometrical element.

The processor may be configured to detect, based on the alignment image set, a (e.g., the) plurality of reference elements of the calibration plate, determine, based on the alignment image set, a position of each detected reference element, and determine the orientation of the calibration plate based on the determined positions of the detected reference elements. Determination of the orientation of the calibration plate may also be determined stepwise through evaluation of each image of the alignment image set directly after taking, checking and correcting the calculated orientation with every further image.

The alignment image set may comprise or consists of one of more of the following images: (i) the first image; (ii) a (e.g., the) third image of a second portion of the calibration plate arranged in the build area, the second portion being different from the first portion; (iii) a (e.g., the) plurality of images of different portions of the calibration plate arranged in the build area.

The processor may be configured to perform the calibration (i) for different laser beams, (ii) for different optical scanning systems of the printing system, each configured to guide a different one of the laser beams to the build area, (iii) for different sizes of the point on the calibration plate irradiated with the laser beam, (iv) for different shapes of the point on the calibration plate irradiated with the laser beam, (v) for different configurations of an (e.g., the) adjustment system of the printing system, the adjustment system having a plurality of configurations, each configuration yielding a different size and/or shape of the point irradiated with the laser beam, (vi) for different first portions, and/or (vii) for different heights of a build platform arranged in the build area and configured to carry the calibration plate.

The irradiation system may comprise a (e.g., the) plurality of optical scanning systems, each configured to guide a different one of the laser beams to the build area. The processor may be configured to calibrate at least one of the plurality of optical scanning systems when calibrating the printing system.

The processor may be configured to perform steps (c) to (e) for at least one further laser beam of the laser beams, in particular each different one of the laser beams, and calibrate the printing system based on the detected position of the at least one part in the first image and the detected positions of the respective spots of light in the second images.

The processor may be configured to (c′) control the irradiation system to irradiate, with (e.g., the) at least one further laser beam of the laser beams, in particular each different one of the laser beams, a (e.g., the) different point on the first portion of the calibration plate arranged in the build area. The processor may be configured to, in step (d), obtain the second image captured by the imaging system, of the first portion of the calibration plate arranged in the build area, the second image comprising the spot of light formed by the one of the one or more laser beams irradiating the point on the first portion of the calibration plate arranged in the build area, the second image further comprising (e.g., the) at least one further spot of light formed by the at least one further laser beam irradiating the different point on the first portion of the calibration plate arranged in the build area. The processor may be configured to (e′) detect a position of the at least one further spot of light in the second image, and calibrate the printing system based the detected position of the at least one part in the first image and the detected positions of the spots of light in the second image.

The irradiation system may comprise an (e.g., the) adjustment system having a plurality of configurations, each configuration yielding a different size and/or shape of the point irradiated with the laser beam on the calibration element arranged in the build area. The processor may be configured to perform steps (c) to (e) for each of the plurality of configurations of the adjustment system, and calibrate the printing system based on the detected position of the at least one part in the first image and the detected positions of the respective spots of light in the second images.

The processor may be configured to perform steps (a) to (e) for each of a (e.g., the) plurality of different first portions, and calibrate the printing system based on the detected positions of the respective at least one part in the first images and the detected position of the respective spots of light in the second images.

The printing system may comprise a (e.g., the) build platform arranged in the build area and configured to carry the calibration plate. In this case, the processor may be configured to perform steps (a) to (e) for each of a (e.g., the) plurality of heights of the build platform when carrying the calibration plate, and calibrate the printing system based on the detected positions of the respective at least one part in the first images and the detected position of the respective spots of light in the second images.

The processor may be configured to obtain correction data indicative of (e.g., the) geometrical parameters of the calibration plate measured with an (e.g., the) external measurement system, and calibrate the printing system based on the correction data.

The processor may be configured to determine a transformation between (i) a (e.g., the) coordinate system of an optical scanning system of the irradiation system, the optical scanning system configured to guide the one of the one or more laser beams to the build area, and (ii) a (e.g., the) coordinate system of the imaging system. The processor may be configured to calibrate the printing system based on the determined transformation.

The printing system may further comprise an (e.g., the) illumination unit configured to illuminate at least the first portion of the calibration plate when the calibration plate is arranged in the build area. The processor may be configured to control the imaging system to capture the first image while at least the first portion of the calibration plate arranged in the build area is illuminated by the illumination unit, and/or control the imaging system to capture the second image(s) while at least the first portion of the calibration plate arranged in the build area is not illuminated by the illumination unit, and/or control the imaging system to capture all images except for the second image(s) while at least the first portion of the calibration plate arranged in the build area is illuminated by the illumination unit.

The imaging system may be arranged such that it captures at least the first image and the second image via an optical scanning system comprised in the irradiation system, the optical scanning system configured to guide at least one of the one or more laser beams to the build area.

The printing system may further comprise the calibration plate, which may optionally be arranged in the build area.

A computer program product may be provided, storing instructions which, when executed by the processor, cause the processor to carry out the method described herein. The computer program may be stored on one or more computer readable media or may be carried by a data stream.

Preferred embodiments of the invention will be described in greater detail with reference to the appended schematic drawings, wherein

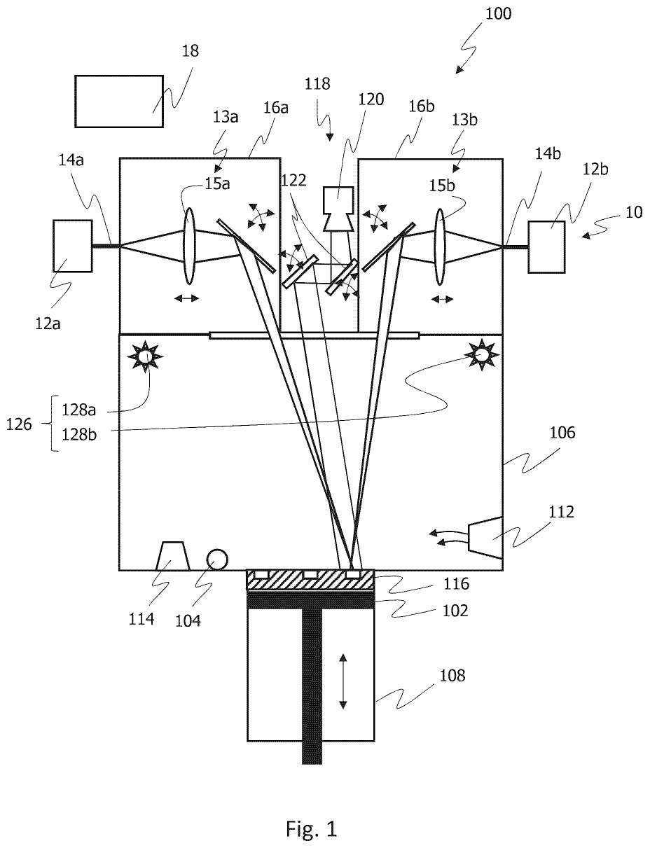

FIG. 1 shows an apparatus for producing a three-dimensional work piece by irradiating layers of a raw material powder with laser radiation;

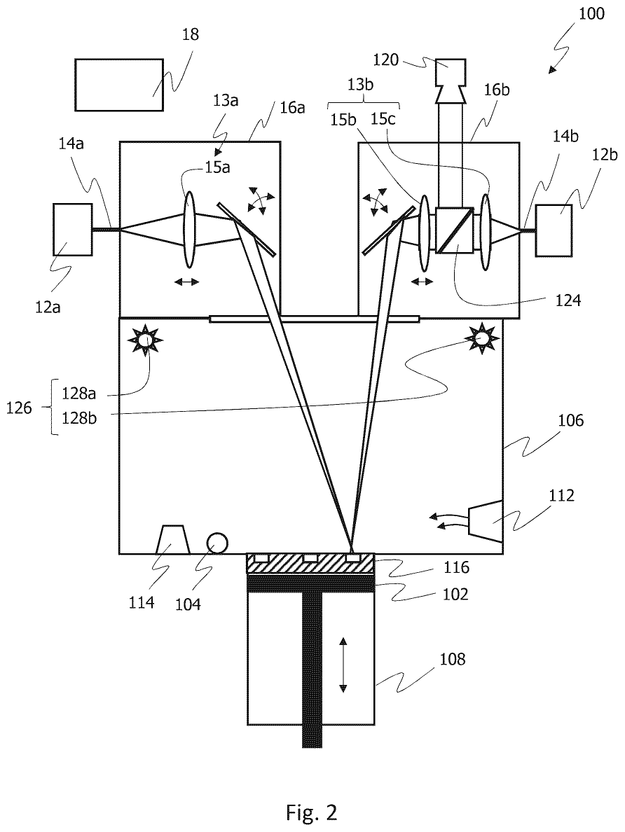

FIG. 2 shows another apparatus for producing a three-dimensional work piece by irradiating layers of a raw material powder with laser radiation;

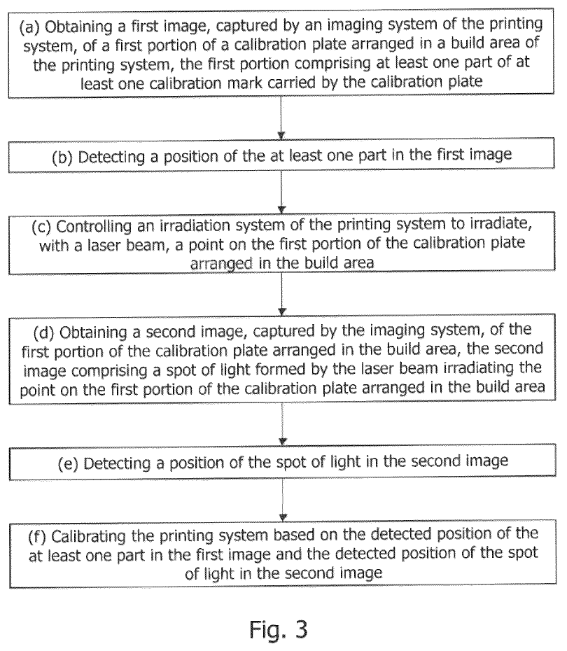

FIG. 3 shows a flow chart of a calibration method;

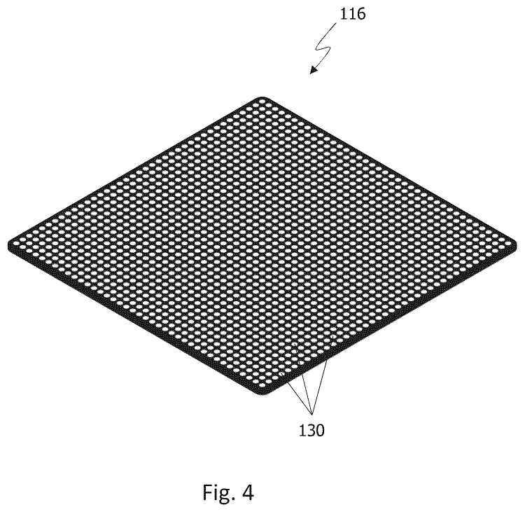

FIG. 4 shows a calibration plate;

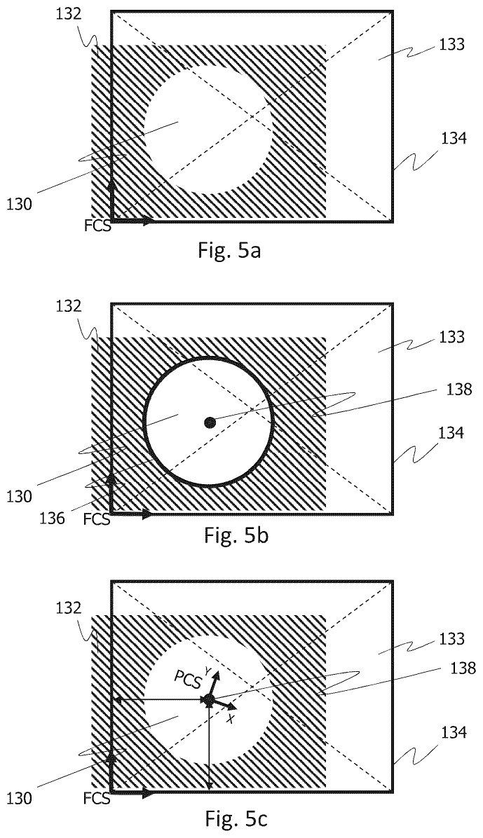

FIGS. 5a-5c illustrate an exemplary first image of the calibration plate;

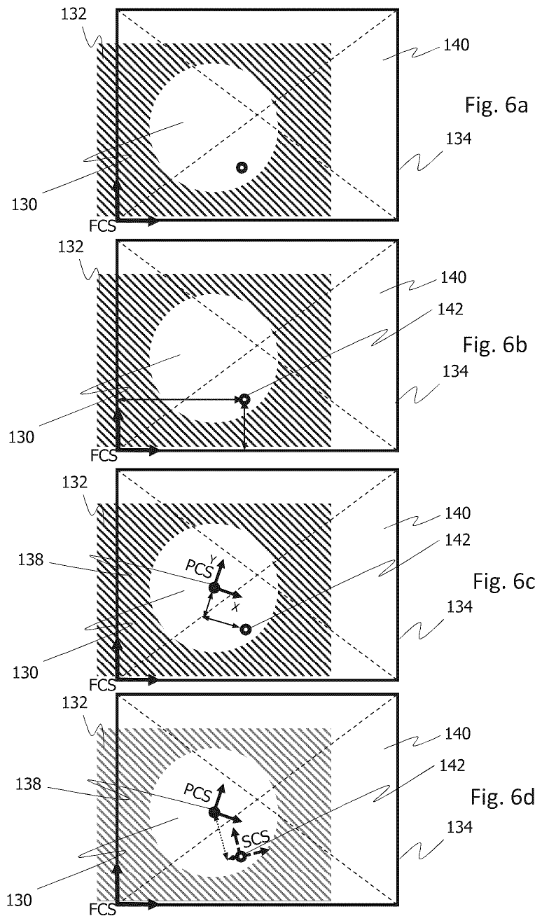

FIGS. 6a-6d illustrate an exemplary second image of the calibration plate;

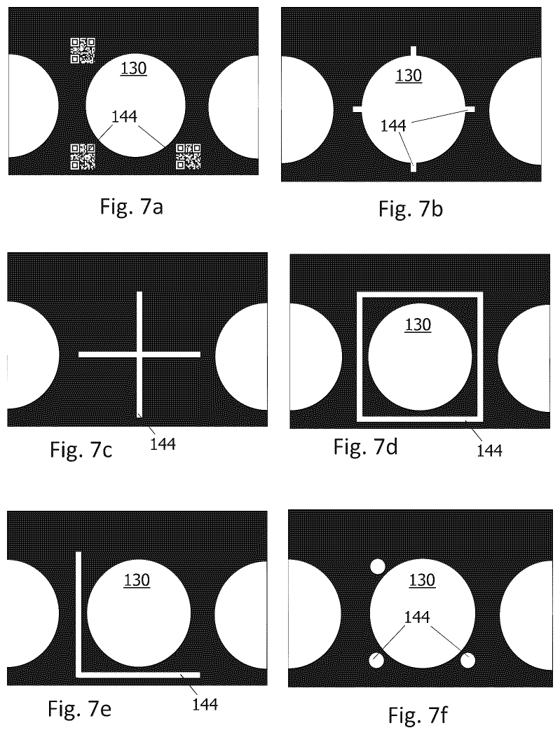

FIGS. 7a-7f show details of the calibration plate;

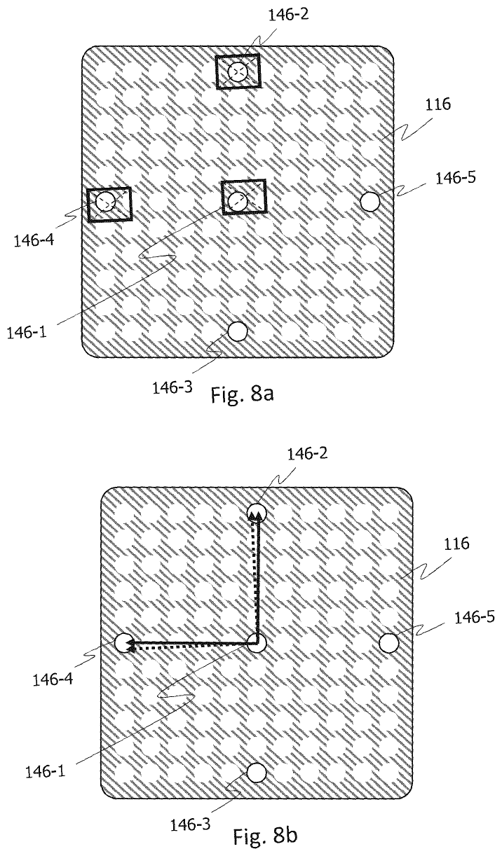

FIGS. 8a-8b illustrate a technique of determining an orientation of the calibration plate;

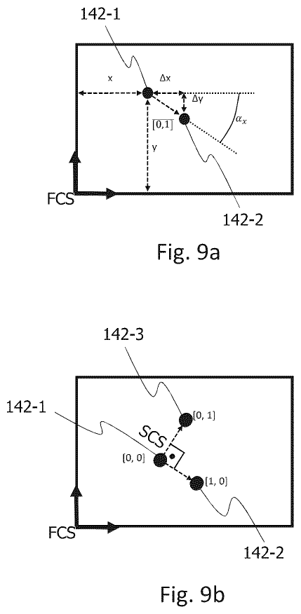

FIGS. 9a-9b illustrate a technique of determining a registration between two coordinate systems;

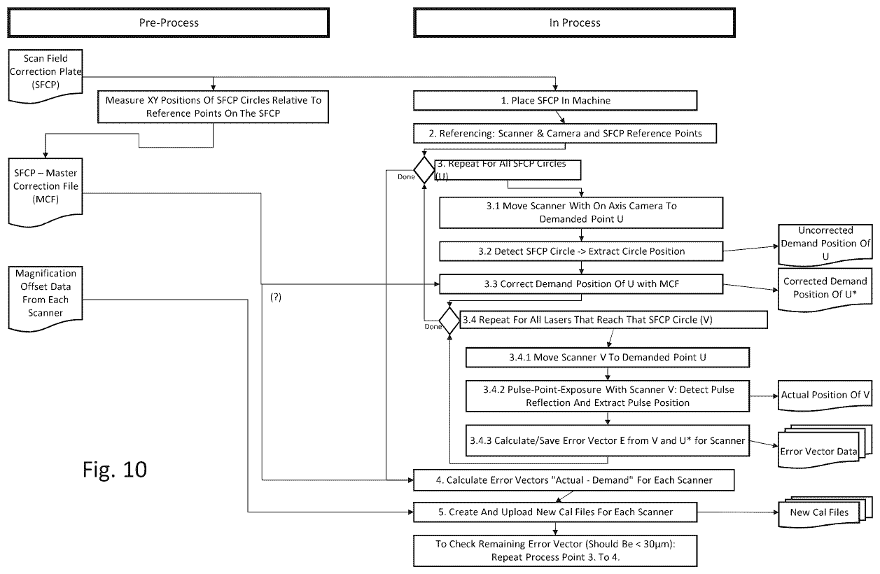

FIG. 10 illustrates a detailed flow chart of a first variant of the calibration method; and

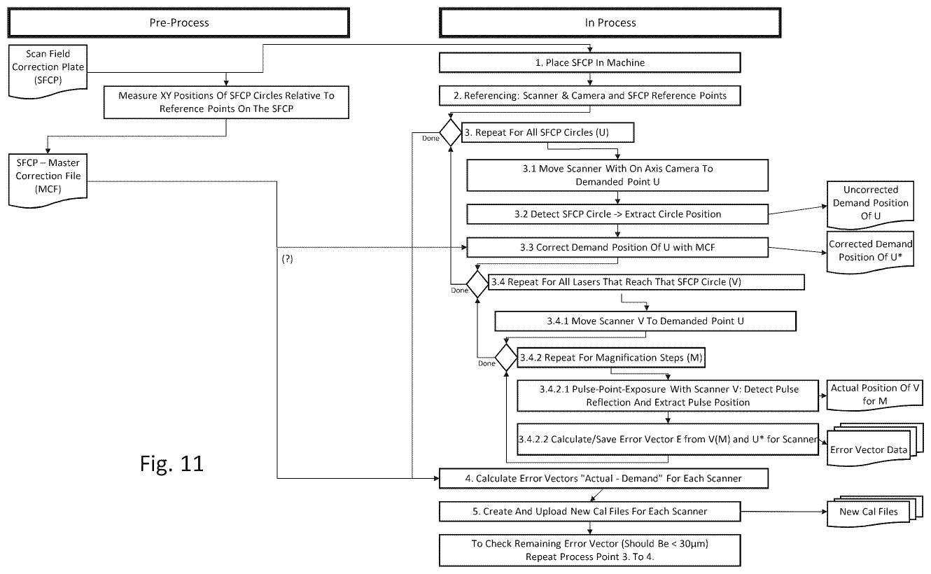

FIG. 11 illustrates a detailed flow chart of a second variant of the calibration method.

FIG. 1 shows a printing system 100 for producing a three-dimensional work piece by an additive layering process. The system 100 comprises a build platform 102 and a powder application device 104 for applying a raw material powder onto the build platform 102. The build platform or carrier 102 and the powder application device 104 are accommodated within a process chamber 106 which is sealable against the ambient atmosphere. The build platform 102 is displaceable in a vertical direction into a built cylinder 108 so that the build platform 102 can be moved downwards with increasing construction height of a work piece 110, as it is built up in layers from the raw material powder on the build platform 102. The build platform 102 may comprise a heater and/or a cooler.

The apparatus 100 further comprises an irradiation system 10 for selectively irradiating laser radiation onto the raw material powder layer 11 applied onto the carrier 102. In the embodiment of an apparatus 100 shown in FIG. 1, the irradiation system 10 comprises two laser beam sources 12a, 12b, each of which is configured to emit a laser beam 14a, 14b. An optical scanning systems 16a, 16b for guiding and processing the laser beams 14a, 14b emitted by the laser beam sources 12a, 12b is associated with each of the laser beam sources 12a, 12b. It is, however, also conceivable that the irradiation system 10 is equipped with only one laser beam source and only one optical scanning system and consequently emits only a single laser beam. An adjustment system 13a, 13b may be formed by some optical components of the respective optical scanning systems 16a, 16b. The adjustment system 13a of the laser beam 14a may for example comprise a lens 15a of the optical scanning system 16a. The same applies to the adjustment system 13b of the laser beam 14b and the lens(es) 15b, 15c of the optical scanning system 16b. Each adjustment system 13a, 13b may be configured to adjust a width, focus and/or shape of the respective laser beam 14a, 14b before the respective laser beam crosses into the build area. A processor 18, also referred to as control device, is provided for controlling the operation of the irradiation system 10 and further components of the apparatus 100 such as, for example, the powder application device 104.

A controlled gas atmosphere, preferably an inert gas atmosphere is established within the process chamber 106 by supplying a shielding gas to the process chamber 106 via a process gas inlet 112. After being directed through the process chamber 106 and across the raw material powder layer 11 applied onto the carrier 102, the gas is discharged from the process chamber 106 via a process gas outlet 114. The process gas may be recirculated from the process gas outlet 114 to the process gas inlet 112 and thereupon may be cooled or heated.

During operation of the apparatus 100 for producing a three-dimensional work piece, a layer of raw material powder is applied onto the carrier 102 by means of the powder application device 104. In order to apply the raw material powder layer 11, the powder application device 104 is moved across the carrier 102 under the control of the control unit 18. Then, again under the control of the control unit 18, the layer of raw material powder is selectively irradiated with laser radiation in accordance with a geometry of a corresponding layer of the work piece 110 to be produced by means of the irradiation device 10. The steps of applying a layer of raw material powder onto the carrier 102 and selectively irradiating the layer of raw material powder with laser radiation in accordance with a geometry of a corresponding layer of the work piece 110 to be produced are repeated until the work piece 110 has reached the desired shape and size.

Before and/or after the production of the three-dimensional workpiece, the printing system 100 may be calibrated. To this end, a calibration plate 116 may be arranged on the build platform 102. The build platform 102 may be positioned such that an upper surface of the calibration plate 116 lies within a plane that corresponds to the surface of the powder layer during the production of a workpiece. The calibration plate 116 is shaped and dimensioned such that it can be positioned in the build area defined by the inner wall surfaces of the cylinder 108. The printing system 100 comprises an imaging system 118 configured to capture an image of at least a first part of the calibration plate 116 when the calibration plate 116 is arranged in the build area.

In the example of FIG. 1, the imaging system 118 comprises a camera 120 and a set of scanning mirrors 122 for shifting the field of view of the camera 120 across the calibration plate 116 upon demand. In difference thereto, in the example of FIG. 2, the imaging system 118 shares optical components with the optical scanning system 16b. In particular, a beam splitter 124 is arranged in the optical path of the laser beam 14b, the beam splitter 124 guiding light originating at the calibration plate 116 toward the camera 120. In this configuration, a laser deflection mirror of the optical scanning system 16b may be used for shifting the field of view of the camera 120. It is noted that the field of view of the camera 120 may be larger than the laser beam irradiating the build area as illustrated in FIG. 2. The camera 120 in the configuration of FIG. 1 may be referred to as an off-axis camera, whereas the camera 120 in the configuration of FIG. 2 may be referred to as an on-axis camera.

The printing system 100 further comprises an illumination unit 126 including a set of light emitting elements 128a, 128b configured to emit light with a predefined spectrum such that the calibration plate 116 is illuminated. The predefined spectrum may be selected in accordance with a sensitivity of the imaging system 118 or vice versa. In other words, the illumination unit 126 may be configured for providing an illumination for an image acquisition of the calibration plate 116 by the imaging unit 118. The imaging system 118 may be insensitive to incident light with a wavelength that corresponds to a wavelength of the laser beam source(s) 12a, 12b. For example, the imaging system 118 may be configured to capture an image using light visible to the human eye and the laser light sources 14a, 14b may be configured to emit infrared laser light. Such a configuration may protect the camera 120 from reflected laser light having a high intensity.

FIG. 3 shows a flow chart of a method in accordance with the present disclosure. The method is performed by the processor 18. In a step (a), a first image is obtained, captured by the imaging system 118 of the printing system 100. The first image comprises a first portion of the calibration plate 116 arranged in the build area of the printing system 100. The first portion of the calibration plate 116 comprises at least one part of at least one calibration mark carried by the calibration plate 116. During the acquisition of the first image, the illumination unit 126 may irradiate the calibration plate 116.

In a step (b), a position of the at least one part in the first image is detected, for example using feature recognition techniques. The illumination of the calibration plate 116 during the acquisition of the first image may yield an image in which there is a high optical contrast between the calibration mark and remaining portions of the calibration plate 116. This may improve accuracy of the detected position of the at least one part of the calibration mark.

In step (c), the irradiation system 10 of the printing system 100 is controlled to irradiate, with one of the laser beams, a point on the first portion of the calibration plate 116 arranged in the build area. At the same time, the illumination unit 126 may be deactivated such that the calibration plate 116 is only irradiated with light from the laser source 12a or 12b.

In step (d) a second image is obtained, captured by the imaging system 118, of the first portion of the calibration plate 116 arranged in the build area, the second image comprising a spot of light formed by the one or the laser beams irradiating the point on the first portion of the calibration plate 116 arranged in the build area. The point of light may be highly visible in the second image due to the deactivation of the illumination unit during the acquisition of the second image.

In step (e), a position of the spot of light in the second image is detected. The accuracy of the detected position may be improved when using a second image captured during an off period of the illumination unit 126.

In step (f), the printing system 100, in particular the optical scanning system 16a or 16b that guided the laser beam to the point on the first portion of the calibration plate 116, is calibrated based on the detected position of the at least one part in the first image and the detected position of the spot of light in the second image. Using separate images may improve the respectively detected positions and, thus, yield a more accurate calibration. Calibrating the optical scanning system(s) 16a, 16b may comprise adjusting a coordinate system of the respective optical scanning system, for example relative to a second coordinate system, such as a coordinate system of the imaging system 118 or a central coordinate system of the printing system 100. Printing data (e.g., irradiation instructions) used by the printing system 100 to form a three-dimensional object may be defined with respect to the central coordinate system. By calibrating the optical scanning system(s) 16a, 16b, any subsequently irradiated positions correspond to the intended positions to be irradiated (e.g., based on the printing data).

FIG. 4 shows an exemplary calibration plate 116. As can be seen, the calibration plate 116 has a black upper surface, for example formed by anodization of the aluminium plate. A plurality of calibration marks 130 are carried by the calibration plate 116. The calibration marks 130 have a higher light reflectivity, at least in the predefined spectrum, compared with the black upper surface and are thus illustrated as white dots. Each calibration mark 130 corresponds to a circular region on the upper surface of the calibration plate 116, the region being either coated with a reflective color or the region not comprising the anodization layer. The calibration marks 130 may be formed by selective laser evaporation or computer controlled milling of parts of the anodization layer. The calibration marks 130 are provided in a symmetrical matrix having rows and columns. Other arrangements of the calibration marks 130 are possible.

As the calibration marks 130 have a higher optical reflectivity (e.g., more than 2 times, 5 times, 10 times or 100 times higher) than the surrounding parts of the calibration plate 116, the at least one part of the at least one calibration mark 130 may be easily detected in the first image, especially if the illumination unit 126 illuminated the calibration plate 116 during acquisition of the first image. Circular calibration marks are easier to detect in the first image compared with more complex geometrical shapes. A center point of a circular calibration mark 130 may be detected or determined based on the first image, even if only a part of the circular calibration mark 130 is visible in the first image.

FIGS. 5a-5c illustrate an exemplary first image 133 of the calibration plate 116. In FIG. 5, a section 132 of the calibration plate 116 is illustrated which comprises a calibration mark 130. The rectangular outline 134 represents the region covered by the first image 133. That is, everything within the outline 134 is visible in the first image 133. The first image 133 has a frame coordinate system FCS, exemplarily indicated in FIGS. 5a-5c in the bottom left corner of the first image 133. As illustrated in FIG. 5b, an outline 136 of the circular calibration mark 130 may be detected in the first image 133.

A center point 138 of the circular outline 136 may then be determined as the position of the calibration mark 130 in the FCS, as illustrated in FIG. 5c. In FIG. 5c, a plate coordinate system, PCS, is indicated with axes “X” and “Y”. The orientation of the PCS relative to the FCS may be determined as described further below with reference to FIGS. 7a-8b.

FIGS. 6a-6d illustrate an exemplary second image 140 of the calibration plate 116. The second image 140 comprises the same section 132 of the calibration plate 116 in the same size and orientation as the first image 133 of FIGS. 5a-5c. One may say that the first image 133 and the second image 140 are views of exactly the same parts of the calibration plate 116. In difference to the first image 133, the second image 140 comprises a spot of light 142 corresponding to a point on the calibration plate 116 that was irradiated with a laser beam during acquisition of the second image 140. Although the calibration mark 130 in the examples of FIGS. 6a to 6d can be seen in the second image 140, this is only for purposes of illustration and is not necessarily the case. That is, the position of the calibration mark 130 may not be detectable from the second image 140.

The position of the spot of light 142 may be determined in the FCS (see FIG. 6b).

An offset between the position of the calibration mark 130 detected in the first image 133, e.g., the center point 138 of the calibration mark 130 in the FCS, and the position of the spot of light 142 detected in the second image 140, e.g. in the FCS, may be determined, as illustrated FIGS. 6c and 6d. This offset may be determined in the FCS. In the example of FIG. 6c, the offset is indicated in the PCS. The offset in the PCS may be determined based on the offset in the FCS and a transformation between the FCS and the PCS. In the example of FIG. 6d, the offset is indicated in the SCS. The offset in the SCS may be determined based on the offset in the FCS and a transformation between the FCS and the SCS. Exemplary techniques of determining the transformation between the FCS and the SCS will be discussed below with reference to FIGS. 9a and 9b. The transformation between the FCS and the SCS may be determined based on images of spots of light obtained by irradiating different positions and/or based on one or more images of a (e.g., asymmetrical or non-circular) light pattern generated by the irradiation system.

The offset(s) may then be used to calibrate the scanning system 16a or 16b used for irradiating the point on the calibration plate 116 during the acquisition of the second image 140. Phrased differently, the detected position 138 may be compared with the detected position of the spot of light 142 to calibrate the printing system 100, in particular the optical scanning system 16a, 16b of the irradiating system 10, which optical scanning system 16a, 16b was used for irradiating the spot of light on the calibration plate 116 when capturing the second image 140. The calibration may comprise correcting, by the offset(s), any future position to be irradiated by the laser beam via the calibrated scanning system 16a, 16b.

An orientation of the calibration plate 116 may be determined based on an alignment image set comprising one or more images acquired by the camera 120. The calibration may then be performed also based on the orientation of the calibration plate 116, in particular based on a transformation between the FCS and the PCS. Two main variants for determining the orientation of the calibration plate 116 relative to the FCS will be described in the following, a first variant with reference to FIGS. 7a-7f and a second variant with reference to FIGS. 8a and 8b. It is noted that these two variants may be combined to obtain a more accurate orientation of the calibration plate 116.

FIGS. 7a-7f show details of the calibration plate 116. In particular, each of these figures show different examples of one or more geometrical elements 144 that may be provided on the calibration plate 116. The geometrical elements 144 may be formed in a similar manner as the calibration marking(s) 130, for example by selective laser ablation.

In the example of FIG. 7a, three QR codes are carried by the calibration plate 116 as geometrical elements 144, each being placed adjacent to a calibration mark 130. By detecting one or all of these QR codes in the first image or in another image of the calibration plate 116 comprised in the alignment image set, an orientation of the detected QR codes in the FCS can be determined. Each QR code may have a predefined orientation (e.g., rotation) relative to the calibration plate 116 (e.g., the PCS). This allows determining the orientation of the calibration plate 116, and in particular determining a rotation between the PCS and the FCS. This rotation may then be used during the calibration process (see FIGS. 5c, 6c and 6d).

In the example of FIG. 7b, the geometrical element 144 comprises a radial line extending outward from the calibration pattern 130. In particular, four lines circumferentially spaced by 90° from one another are provided as geometrical elements 144. This may allow for a detection of a misalignment between the PCS and the FCS of <45°. More (e.g., unsymmetric) lines may be added to allow detection of a misalignment between the PCS and the FCS of more than 45° without ambiguity.

In the example of FIG. 7c, the geometrical element 144 is a cross or plus-shape formed by two orthogonal intersecting lines. Also in this case, some ambiguity regarding the orientation of the calibration plate 116 may remain.

In the example of FIG. 7d, the geometrical element 144 is a square surrounding one of the calibration marks 130. Also in this case, some ambiguity regarding the orientation of the calibration plate 116 may remain. The ambiguity may either be acceptable (e.g., in case the calibration plate 116 cannot be arranged in the build area with a misalignment of >45°) or may be minimized by adding additional geometrical elements 144 such as lines, dots or the like.

In the example of FIG. 7e, the geometrical element 144 is an L-shape formed by two orthogonal lines having joined ends. In this case, the geometrical element 144 has only one axis of symmetry. Thus, similar to unsymmetrical geometrical elements 144, the orientation of the calibration plate 116 can be precisely determined without ambiguity.

In the example of FIG. 7f, three circles are carried by the calibration plate 116 as geometrical elements 144, each being placed adjacent to a calibration mark 130. The circles together form a pattern with only one axis of symmetry. Thus, similar to unsymmetrical geometrical elements 144, the orientation of the calibration plate 116 can be precisely determined without ambiguity.

FIGS. 8a-8b illustrate a technique of determining an orientation of the calibration plate 116 using a plurality of reference elements 146 carried by the calibration plate 116. In this case, the orientation of the calibration plate 116 is determined based on a plurality of positions, not orientations, of the plurality of reference elements 146. In the example shown, five of the calibration elements 130 serve as reference elements 146: one reference element 146-1 on the center of the calibration plate 116, two reference elements 146-2, 146-3 at ends of a vertical center axis of the calibration plate 116, and two reference elements 146-4, 146-5 at ends of a horizontal center axis of the plate 116. As shown in FIG. 8a, three images may be captured as the alignment image set, each comprising a different one of the reference elements 146, wherein at least one of the images preferably comprises the central reference element 146-1. The positions of the reference elements 146 can be determined in the three captured images. The orientation of the calibration plate 116 relative to the imaging system 118, in particular a rotational offset between the FCS and the PCS, may then be determined based on the detected positions of the reference elements 146, as schematically illustrated in FIG. 8b.

The calibration may be performed further based on a transformation between the coordinate systems FCS and SCS. FIGS. 9a and 9b illustrate a technique of determining such a transformation, also referred to as a “registration” between the coordinate systems FCS and SCS.

In the technique according to FIG. 9a, an on-axis camera 120 is used, for example as illustrated in FIG. 2. During irradiation of a point on the calibration plate 116 by the laser beam, an image is captured (e.g., the second image 140). The spot of light 142-1 is detected in the captured image, in the FCS. Next, the camera's field of view is shifted into a predetermined direction and by a predetermined amount. In the example of FIG. 9a, it is shifted into the position [0, 1] according to the FCS. Then, another image is captured while the laser beam irradiates the same point on the calibration plate 116. Due to the shifted field of view of the camera 120, the position of the detected spot of light will now be different. In the example shown in FIG. 9a, the detected position of the spot of light 142-2 in the FCS is offset from the detected position of the spot of light 142-1 in the FCS in the x-axis by the amount Ax and the y-axis direction of the FCS by the amount Ay. An offset angle ax between the FCS and the SCS may be determined based on the detected positions of the spots of light 142-1, 142-2. Thus, this technique allows determining a transformation, also referred to as registration, between the coordinate systems FCS and SCS. The FCS may be defined relative to each image acquired by the imaging system 118. It is noted that instead of detecting the spots of lights 142-1, 142-2, the positions of a same calibration mark, geometrical element or reference element depicted by the two images may be detected in the FCS.

In the technique according to FIG. 9b, an off-axis camera 120 may be used, for example as illustrated in FIG. 1. During irradiation of a first point on the calibration plate 116 by the laser beam, an image is captured (e.g., the second image 140). The spot of light 142-1 is detected in the captured image, in the FCS. Next, a second point on the calibration plate 116 is irradiated, the second point being offset from the first point in a predetermined direction and by a predetermined amount. In the example of FIG. 9b, the second point is offset from the first point in the x-axis direction of the SCS by the exemplary amount of 1. Thus, the first point may be described as having the coordinates [0, 0] in the SCS, whereas the second point has the coordinates [1, 0] in the SCS. An image is captured and the position of the spot of light 142-2 formed by the laser beam irradiating the second point is detected in the FCS. Next, a third point on the calibration plate 116 is irradiated, the third point being offset from the first point in another predetermined direction and by another predetermined amount. In the example of FIG. 9b, the third point is offset from the first point in the y-axis direction of the SCS by the exemplary amount of 1. Thus, the first point may be described as having the coordinates [0, 0] in the SCS, whereas the third point has the coordinates [0, 1] in the SCS. An image is captured and the position of the spot of light 142-3 formed by the laser beam irradiating the third point is detected in the FCS. The detected positions of the spots of light 142-1, 142-2 and 142-3 may be used to determine an orientation of the SCS relative to the FCS. That is, the registration between the SCS and the FCS may be determined based on the detected positions of the spots of light 142-1, 142-2 and 142-3.

FIG. 10 illustrates a detailed flow chart of a first variant of the method. The calibration plate is referred to as Scan Field Correction Plate, SFCP. The calibration marks 130 are referred to as SFCP circles. The optical scanning system of a laser beam is referred to as “Scanner”. The Reference Points may be grooves, indents or other features of the calibration plate 116. Optional steps are marked with a question mark, i.e., the MCF may either be used in step 3.3, used in step 4, or not be used at all.

The MCF describes geometrical parameters of the calibration plate 116 that are measured with an external measurement system. For example, the MCF may describe deviations between theoretical geometrical properties of the calibration plate 116 (e.g., locations of the calibration marks 130, the geometrical elements 144 and other features of the calibration plate 116) and the real geometrical properties of the calibration plate 116 as measured with the external measurement system. The MCF 116 may thus be considered as the “gold standard” of the positions of the respective marks, elements and features of the calibration plate 116 (e.g., relative to the PCS defined by one or more Reference Points or position markers carried by the calibration plate 116).

The Magnification Offset Data from each scanner corresponds to calibration parameters used for calibrating the respective scanner for different configurations of the adjustment system of the respective scanner. In the example of FIG. 10, the

Magnification Offset Data is predetermined, for example provided by a manufacturer of the optical scanning system or during service. The “Cal file” may correspond to a calibration file defining calibration parameters (e.g., spatial offsets to apply during irradiation) for each optical scanning system of the printing system 100.

FIG. 11 illustrates a detailed flow chart of a second variant of the method. In difference to FIG. 10, the Magnification Offset Data is not predetermined in this case. Thus, steps 3.4.2.1 and 3.4.2.2 are repeated for all magnification steps M, each magnification step corresponding to a different configuration of the adjustment system of the respective optical scanning system or “Scanner”. Apart from that difference, the method of FIG. 11 corresponds to that of FIG. 10. Both methods result in a calibration of the printing system 100 via the Cal files.

As apparent from FIGS. 10 and 11, the calibration method described herein may be performed for a plurality of configurations of the printing system 100. For example, the calibration may be performed for different laser beams 14a, 14b of the irradiation system 10 and/or for different optical scanning systems 16a, 16b of the irradiation system 10, each configured to guide a different laser beam 14a, 14b to the build area and/or for different sizes of the point on the calibration plate 116 irradiated with the laser beam 14a, 14b and/or for different shapes of the point on the calibration plate 116 irradiated irradiated with the laser beam 14a, 14b and/or for different configurations of the adjustment system 13a, 13b of the irradiation system 10, each configuration yielding a different size and/or shape of the point irradiated with the laser beam 14a, 14b and/or for different first portions and/or for different vertical positions of the build platform 102 arranged in the build area and carrying the calibration plate 116.

The method may be repeated after having performed the calibration, wherein, in step (f), a difference between the detected positions may be compared with a predefined offset threshold to validate whether the previously performed calibration was sufficient or not. Depending on the outcome of the comparison with the offset threshold, another calibration may be performed as described herein. Once the validation indicates that the difference between the detected positions is lower than the predefined offset threshold, a three-dimensional workpiece may be produced, preferably after having removed the calibration plate 116 from the build platform 102. The so-produced three-dimensional workpiece may have lower manufacturing tolerances, a higher stiffness and other advantageous physical properties compared to a workpiece produced with the printing system 100 before having performed the calibration.

1-15. (canceled)

16. A calibration method for a printing system, the printing system configured to produce a three-dimensional workpiece, the method performed by a processor and comprising:
(a) obtaining a first image, captured by an imaging system of the printing system, of a first portion of a calibration plate arranged in a build area of the printing system, the first portion comprising at least one part of at least one calibration mark carried by the calibration plate;
(b) detecting a position of the at least one part in the first image;
(c) controlling an irradiation system of the printing system to irradiate, with a laser beam, a point on the first portion of the calibration plate arranged in the build area;
(d) obtaining a second image, captured by the imaging system, of the first portion of the calibration plate arranged in the build area, the second image comprising a spot of light formed by the laser beam irradiating the point on the first portion of the calibration plate arranged in the build area;
(e) detecting a position of the spot of light in the second image; and
(f) calibrating the printing system based on the detected position of the at least one part in the first image and the detected position of the spot of light in the second image.

17. The method of claim 16, wherein at least one of the following conditions is met:
(a) the printing system is calibrated based on a comparison of the detected position of the at least one part in the first image and the detected position of the spot of light in the second image;
(b) the first image and the second image cover the same field of view;
(c) an alignment of the first portion in the first image is identical to an alignment of the first portion in the second image.

18. The method of claim 16, wherein the irradiation system is calibrated to calibrate the printing system.

19. The method of claim 16, comprising:
obtaining an alignment image set comprising one or more images, captured by the imaging system, of at least one portion of the calibration plate arranged in the build area; and
determining an orientation of the calibration plate based on the alignment image set,
wherein the printing system is calibrated based on the determined orientation of the calibration plate.

20. The method of claim 19, comprising:
detecting, in at least one of the images of the alignment image set, a geometrical element on the calibration plate;
determining an orientation of the detected geometrical element in the at least one image; and
determining the orientation of the calibration plate based on the determined orientation of the detected geometrical element.

21. The method of claim 20, comprising:
detecting, based on the alignment image set, a plurality of reference elements of the calibration plate;
determining, based on the alignment image set, a position of each detected reference element; and
determining the orientation of the calibration plate based on the determined positions of the detected reference elements.

22. The method of claim 16, wherein the calibration is performed
(i) for different laser beams of the irradiation system,
(ii) for different optical scanning systems of the irradiation system, each configured to guide a different laser beam to the build area,
(iii) for different sizes of the point on the calibration plate irradiated with the laser beam,
(iv) for different shapes of the point on the calibration plate irradiated irradiated with the laser beam,
(v) for different configurations of an adjustment system of the irradiation system, each configuration yielding a different size and/or shape of the point irradiated with the laser beam,
(vi) for different first portions, and/or
(vii) for different heights of a build platform arranged in the build area and carrying the calibration plate.

23. The method of claim 16, comprising:
obtaining correction data indicative of geometrical parameters of the calibration plate measured with an external measurement system,
wherein the printing system is calibrated based on the correction data.

24. The method of claim 16, comprising:
determining a transformation between
(i) a coordinate system of an optical scanning system of the irradiation system, the optical scanning system configured to guide the laser beam to the build area, and
(ii) a coordinate system of the imaging system, wherein the printing system is calibrated based on the determined transformation.

25. The method of claim 16, wherein the printing system further comprises an illumination unit configured to illuminate at least the first portion of the calibration plate when the calibration plate is arranged in the build area, the method comprising:
controlling the imaging system to capture the first image while at least the first portion of the calibration plate arranged in the build area is illuminated by the illumination unit; and/or
controlling the imaging system to capture the second image(s) while at least the first portion of the calibration plate arranged in the build area is not illuminated by the illumination unit; and/or
controlling the imaging system to capture all images except for the second image(s) while at least the first portion of the calibration plate arranged in the build area is illuminated by the illumination unit.

26. The method of claim 16, wherein the imaging system is arranged such that it captures at least the first image and the second image via an optical scanning system comprised in the irradiation system, the optical scanning system configured to guide the laser beam to the build area.

27. A printing system for producing a three-dimensional workpiece, comprising:
an irradiation system configured to selectively irradiate a build area with one or more laser beams;
an imaging system configured to capture an image of at least a portion of a calibration plate when the calibration plate is arranged in the build area; and
a processor configured to:
(a) obtain a first image, captured by the imaging system, of a first portion of the calibration plate arranged in the build area, the first portion comprising at least one part of at least one calibration mark carried by the calibration plate;
(b) detect a position of the at least one part in the first image;
(c) control the irradiation system to irradiate, with one of the one or more laser beams, a point on the first portion of the calibration plate arranged in the build area;
(d) obtain a second image, captured by the imaging system, of the first portion of the calibration plate arranged in the build area, the second image comprising a spot of light formed by the one of the one or more laser beams irradiating the point on the first portion of the calibration plate arranged in the build area;
(e) detect a position of the spot of light in the second image; and
(f) calibrate the printing system based on the detected position of the at least one part in the first image and the detected position of the spot of light in the second image.

28. The printing system of claim 27, further comprising at least one of the following:
(i) one or more optical scanning systems, each configured to guide a different one of the laser beams to the build area,
(ii) an adjustment system having a plurality of configurations, each configuration yielding a different size and/or shape of the point irradiated with the laser beam,
(iii) a build platform arranged in the build area and configured to carry the calibration plate,
(iv) an illumination unit configured to illuminate at least the first portion of the calibration plate when the calibration plate is arranged in the build area,
(v) an on-axis camera, (vi) the calibration plate.

29. The printing system of claim 27, wherein the processor is configured to perform at least one of the following actions:
(a) calibrate the printing system based on a comparison of the detected position of the at least one part in the first image and the detected position of the spot of light in the second image;
(b) calibrate the irradiation system to calibrate the printing system;
(c) obtain correction data indicative of geometrical parameters of the calibration plate measured with an external measurement system, and calibrate the printing system based on the correction data;
(d) determine a transformation between (i) a coordinate system of an optical scanning system of the irradiation system, the optical scanning system configured to guide the laser beam to the build area, and (ii) a coordinate system of the imaging system, and calibrate the printing system based on the determined transformation;

30. The printing system of claim 27, wherein at least one of the following conditions is met:
(e) the first image and the second image cover the same field of view;
(f) an alignment of the first portion in the first image is identical to an alignment of the first portion in the second image;
(g) the imaging system is arranged such that it captures at least the first image and the second image via an optical scanning system comprised in the irradiation system, and the optical scanning system is configured to guide the laser beam to the build area.

31. The printing system of claim 27, wherein the processor is configured to:
obtain an alignment image set comprising one or more images, captured by the imaging system, of at least one portion of the calibration plate arranged in the build area;
determine an orientation of the calibration plate based on the alignment image set; and
calibrate the printing system based on the determined orientation of the calibration plate.

32. The printing system of claim 31, wherein the processor is configured to:
(i) detect, in at least one of the images of the alignment image set, a geometrical element on the calibration plate;
determine an orientation of the detected geometrical element in the at least one image; and
determine the orientation of the calibration plate based on the determined orientation of the detected geometrical element; and/or
(ii) detect, based on the alignment image set, a plurality of reference elements of the calibration plate;
determine, based on the alignment image set, a position of each detected reference element; and
determine the orientation of the calibration plate based on the determined positions of the detected reference elements.

33. The printing system of claim 27, wherein the processor is configured to perform the calibration
(i) for different laser beams of the irradiation system,
(ii) for different optical scanning systems of the irradiation system, each configured to guide a different laser beam to the build area,
(iii) for different sizes of the point on the calibration plate irradiated with the laser beam,
(iv) for different shapes of the point on the calibration plate irradiated irradiated with the laser beam,
(v) for different configurations of an adjustment system of the irradiation system, each configuration yielding a different size and/or shape of the point irradiated with the laser beam,
(vi) for different first portions, and/or
(vii) for different heights of a build platform arranged in the build area and carrying the calibration plate.

34. The printing system of claim 27, further comprising an illumination unit configured to illuminate at least the first portion of the calibration plate when the calibration plate is arranged in the build area, wherein the processor is configured to:
control the imaging system to capture the first image while at least the first portion of the calibration plate arranged in the build area is illuminated by the illumination unit; and/or
control the imaging system to capture the second image(s) while at least the first portion of the calibration plate arranged in the build area is not illuminated by the illumination unit; and/or
control the imaging system to capture all images except for the second image(s) while at least the first portion of the calibration plate arranged in the build area is illuminated by the illumination unit.

35. A computer readable medium storing a computer program which, when executed by a processor of a printing system configured to produce a three-dimensional workpiece, cause the processor to:
(a) obtain a first image, captured by an imaging system of the printing system, of a first portion of a calibration plate arranged in a build area of the printing system, the first portion comprising at least one part of at least one calibration mark carried by the calibration plate;
(b) detect a position of the at least one part in the first image;
(c) control an irradiation system of the printing system to irradiate, with a laser beam, a point on the first portion of the calibration plate arranged in the build area;
(d) obtain a second image, captured by the imaging system, of the first portion of the calibration plate arranged in the build area, the second image comprising a spot of light formed by the laser beam irradiating the point on the first portion of the calibration plate arranged in the build area;
(e) detect a position of the spot of light in the second image; and
(f) calibrate the printing system based on the detected position of the at least one part in the first image and the detected position of the spot of light in the second image.
